(19) United States
(12) Patent Application Publication
(10) Pub. No.: US 2013/0251773 A1
(43) Pub. Date: Sep. 26, 2013

(54) Controlled Release Insect Repellent Materials

(71) Applicant: CELANESE EVA PERFORMANCE POLYMERS, INC., Irving, TX (US)

(72) Inventors: Vassilios Galiatsatos, Lebanon, OH (US); Jeffrey C. Haley, Norwood, OH (US); J. Gregory Little, Irving, TX (US)

(73) Assignee: Celanese EVA Performance Polymers, Inc., Irving, TX (US)

(21) Appl. No.: 13/833,080

(22) Filed: Mar. 15, 2013

Related U.S. Application Data
(60) Provisional application No. 61/614,885, filed on Mar. 23, 2012.

(51) Int. Cl. A01N 25/10

(52) U.S. Cl. CPC A01N 25/10
USPC 424/403; 424/409; 514/772.4; 514/772.3; 514/781

(57) ABSTRACT

Generally, controlled release insect repellent materials include at least one polymer selected from the group consisting of an ethylene copolymer, an ethyl cellulose, a thermoplastic polyurethane, and any combination thereof and at least one insect repellent and may optionally include at least one insect repellent synergist, at least one additive, at least one additional polymer, and any combination thereof. Further, controlled release insect repellent materials may be used to form articles or products with long-term efficacy.

### CROSS-REFERENCE TO RELATED APPLICATIONS

This application claims the benefit of U.S. Provisional Application No. 61/614,855 filed on Mar. 23, 2012.

### BACKGROUND

The present invention relates to the controlled release of insect repellents through a polymeric matrix, and more specifically, polymer matrices comprising ethylene copolymers, ethyl celluloses, and/or thermoplastic polyurethanes for the controlled release of insect repellents.

Traditionally, insect repellents for use in agricultural or personal use applications have been dispersed in liquid form, for example, dispersed in a volatile liquid. As used herein, the term “insect repellent” refers to both insect repellents and insecticides. Such dispersion techniques, generally allow for either immediate to short-term efficacy (e.g., minutes to hours) or for absorption into a surrounding medium (e.g., the ground) with the intention of a more medium-term efficacy (e.g., days to weeks). However, there has yet to be a solution for single-dose applications where longer-term efficacy (e.g., months) is desired.

To fill in this technology gap, several configurations have been designed including wicks immersed in a liquid and saturated cellulose waddings or papers. Wicks immersed in a liquid can allow for volatilization and dispersion of insect repellents over longer time frames. However, the volatilization rate can be high, which necessitates larger volumes of dilute liquids. Further, the general design of wicks immersed in liquids provides for very few implementation avenues. That is, this design allows for primarily in-home uses.

With the saturated cellulose waddings or papers technologies, controlling the rate of release to provide for longer-term efficacy generally requires the use of the housing that limits the exposure of the wadding or paper to the atmosphere. Further, similar to the wick immersed in liquids technology, this technology provides for generally in-home uses and may be expanded to personal use applications.

Therefore, a technology for longer-term efficacy of insect repellents with the capability of being designed for applications in a variety of sectors, e.g., agricultural and personal uses, may be of value to one skilled in the art.

### SUMMARY OF THE INVENTION

The present invention relates to the controlled release of insect repellents through a polymeric matrix, and more specifically, polymer matrices comprising ethylene copolymers, ethyl celluloses, and/or thermoplastic polyurethanes for the controlled release of insect repellents.

One embodiment of the present invention provides for a layered article that includes an adhesive layer; and an insect repellent layer comprising a controlled release insect repellent material. Generally, a controlled release insect repellent material includes an insect repellent and at least one polymer selected from the group consisting of an ethylene copolymer, an ethyl cellulose, a thermoplastic polyurethane, and any combination thereof.

Another embodiment of the present invention provides for a molded article that includes a controlled release insect repellent material. Generally, a controlled release insect repellent material includes an insect repellent and at least one polymer selected from the group consisting of an ethylene copolymer, an ethyl cellulose, a thermoplastic polyurethane, and any combination thereof.

Yet another embodiment of the present invention provides for a fabric that includes a controlled release insect repellent material in fiber form. Generally, a controlled release insect repellent material includes an insect repellent and at least one polymer selected from the group consisting of an ethylene copolymer, an ethyl cellulose, a thermoplastic polyurethane, and any combination thereof.

One embodiment of the present invention provides for a method that includes mixing an insect repellent in a polymer melt comprising at least one polymer selected from the group consisting of an ethylene copolymer, an ethyl cellulose, a thermoplastic polyurethane, and any combination thereof; producing a controlled release insect repellent material from the polymer melt having insect repellent therein; and producing an article comprising the controlled release insect repellent material.

Another embodiment of the present invention provides for a method that includes absorbing an insect repellent into a matrix so as to form a controlled release insect repellent material, the matrix comprising at least one polymer selected from the group consisting of an ethylene copolymer, an ethyl cellulose, a thermoplastic polyurethane, and any combination thereof; and producing an article from the controlled release insect repellent material.

Yet another embodiment of the present invention provides for a method that includes applying an insect repellent to a surface; and applying a polymer melt to the surface having insect repellent thereon thereby forming a controlled release insect repellent material, the polymer melt comprising at least one polymer selected from the group consisting of an ethylene copolymer, an ethyl cellulose, a thermoplastic polyurethane, and any combination thereof.

Another embodiment of the present invention provides for a method that includes mechanically breaking down a controlled release insect repellent material into particles having at least one dimension ranging from about 10 nm to about 1 mm; and incorporating the particles into a delivery medium or an article. Generally, a controlled release insect repellent material includes an insect repellent and at least one polymer selected from the group consisting of an ethylene copolymer, an ethyl cellulose, a thermoplastic polyurethane, and any combination thereof.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-G provide nonlimiting illustrations of bicomponent fiber configurations.

FIGS. 2A-F provide nonlimiting examples for configurations of layered articles comprising controlled release insect repellent materials (CRIRM) of the present invention.

FIGS. 3A-C provide nonlimiting examples of configurations of articles or products comprising CRIRM of the present invention.

### DETAILED DESCRIPTION

The present invention relates to the controlled release of insect repellents through a polymeric matrix, and more specifically, polymer matrices comprising ethylene copolymers, ethyl celluloses, and/or thermoplastic polyurethanes for the controlled release of insect repellents.

The present invention, in some embodiments, provides for articles and methods for long-term controlled release of insect repellents from a polymer matrix comprising at least one polymer selected from the group consisting of an ethylene copolymer, an ethyl cellulose, a thermoplastic polyurethane, and any combination thereof. Further, some embodiments of the present invention provide for unique structures that enable implementation in a wide variety of applications, e.g., personal, home, agricultural, textiles, films, coatings, and the like.

The use of ethylene copolymers may advantageously provide for tailorability of the release rate of the insect repellents for a particular application, e.g., by varying the crystallinity of the ethylene copolymers. The tailorability and unique structures provided in some articles of the present invention may synergistically, in some embodiments, provide for the controlled release of more than one insect repellent or insect repellent synergists (described further below), which may enhance the efficacy of the article. By way of nonlimiting example, articles may be designed with three regions each with a different insect repellent or insect repellent synergist in such a configuration to allow for different release rates of each. This type of tailorability, in some embodiments, may allow for release of the first insect repellent with an initial high release rate so as to create a “burst” for short-term efficacy and then a sustained release of the second insect repellent at a lower release rate for long-term efficacy.

Further, because ethylene copolymers can be used in conjunction with a plurality of other materials without the need for an adhesive layer therebetween, the use of ethylene copolymers may advantageously provide for fewer manufacturing steps. By way of nonlimiting example, a patch having a backing layer and a controlled release insect repellent material disposed thereon may be produced, in some embodiments, without an adhesive layer therebetween.

Additionally, some embodiments of the present invention provide for complex structures that further enhance the controlled release of insect repellents, especially when two or more insect repellents are incorporated.

### I. Controlled Release Insect Repellent Materials

In some embodiments, controlled release insect repellent materials (referred to herein for convenience as “CRIRM”) of the present invention may comprise at least one insect repellent and at least one polymer selected from the group consisting of an ethylene copolymer, an ethyl cellulose, a thermoplastic polyurethane, and any combination thereof. As mentioned above, as used herein, the term “insect repellent” refers to both insect repellents and insecticides.

Suitable insect repellents for use in conjunction with the present invention may include, but are not limited to, natural repellents (e.g., essential oils, citronella, sodium laurel sulfate, cedar, neem, clove, thyme, lavender, eucalyptus, peppermint, lemongrass, garlic, capsaicin, sabadillia, rotenone, nicotine, and pyrethrum), synthetic repellents (e.g., N,N-dimethyl-meta-toluamide (DEET), dichlorodiphenyltrichloroethane (DDT), organophosphate-based insecticides, pyrethroids, picaridin, boric acid, cyfluthrin, deltamethrin, fenthion, propoxur, sevin, dinotefuran, acephate, chlorophyrifos, diazinon, horticultural oil, malathion, and methoxyclor), insect controlling pheromones, and the like, or any combination thereof. Suitable insecticides for use in conjunction with the present invention may include, but are not limited to, acid copper chromate (ACC), acetamiprid, bifenazate, chlorantraniliprole, chlorfenapyr, clothianidin, dinotefuran, ethiprole, flubendiamide, flufenoxuron, imiprothrin, indoxacarb, metrafenone, nicarbazin, n-methylneodecanamide, phosphine, pirimicarb, pyridalyl, spinetoram, spinosad, spirodiclofen, spirotetramat, tebufenpyrad, thiacloprid, pyrethrin, allethrin, prallethrin, furamethrin, phenothrin, permethrin, silafluofen, hinokitiol, isopropylmethyl phenol, 5-chloro-2-trifluoromethanesulfonamide methyl benzoate, taufluvalinate, flumethrin, trans-cyfluthrin, kadethrin, bioresmethrin, tetramethrin, empenthrin, cyphenothrin, bioallethrin, an oxadiazine derivative, a chloronicotinyl, a nitroguanidine, a pyrrol, a pyrazone, a diacylhydrazine, a triazole, a biological/fermentation product, a phenyl pyrazole, an organophosphate, a carbamate, a pyrethrin, d-trans allethrin, esbiol, esbiothrin, pynamin forte, n-octyl bicycloheptene dicarboximide, and the like, or any combination thereof.

In some embodiments, a CRIRM of the present invention may include an insect repellent in an amount ranging from a lower limit of about 0.1%, 1%, 5%, or 10% by weight of the CRIRM to an upper limit of about 40%, 30%, or 20% by weight of the CRIRM, and wherein the amount of insect repellent may range from any lower limit to any upper limit and encompass any subset therebetween. One skilled in the art with the benefit of this disclosure should understand that some insect repellents may act as a plasticizer for the polymer of CRIRM, which may influence the properties of the final CRIRM. To account for any plastizing effects, one may, inter alia, change the characteristics of the polymer characteristics (e.g., crystallinity, as described below) or the addition of additional polymers or additives.

In some embodiments, a CRIRM of the present invention may comprise at least one insect repellent synergist, at least one insect repellent, and at least one polymer selected from the group consisting of an ethylene copolymer, an ethyl cellulose, a thermoplastic polyurethane, and any combination thereof. As used herein, the term “insect repellent synergist” refers to a chemical or biological compound that interferes with an insect's ability to mitigate the effects of an insect repellent. Therefore, insect repellent synergists may, in some embodiments, synergistically enhance the efficacy of a CRIRM. Nonlimiting examples of insect repellent synergists include piperonyl butoxide, dietholate, sesamex, sulfoxide, butcarpolate, sesamolin, jiajizengxiaolin, octachlorodipropylether, piperonyl cyclonene, piprotal, propylisome, or any combination thereof. By way of nonlimiting example, a CRIRM may comprise piperonyl butoxide and pyrethroids and/or rotenone. By way of another nonlimiting example, a CRIRM may comprise piperonyl butoxide and n-octyl bicycloheptene dicarboximide.

In some embodiments, a CRIRM of the present invention may include an insect repellent synergist in an amount ranging from a lower limit of about 0.1%, 1%, or 5% by weight of the CRIRM to an upper limit of about 40%, 30%, 20%, 10%, or 5% by weight of the CRIRM, and wherein the amount of insect repellent synergist may range from any lower limit to any upper limit and encompass any subset therebetween. In some embodiments, a CRIRM of the present invention may include an insect repellent synergist in an amount ranging from a lower limit of about 1 times, 2 times, or 3 times the concentration of the insect repellent to an upper limit of about 10 times, 8 times, or 5 times the concentration of the insect repellent, and wherein the amount of insect repellent synergist relative to the insect repellent may range from any lower limit to any upper limit and encompass any subset therebetween. One skilled in the art with the benefit of this disclosure should understand that similar to the insect repellents, insect repellent synergists may act as a plasticizer for the polymer of CRIRM, which may influence the properties of the final CRIRM. By way of nonlimiting example, a CRIRM of the present invention may comprise piperonyl butoxide at about 5 times the concentration of n-octyl bicycloheptene dicarboximide.

Examples of ethylene copolymers may include, but are not limited to, polymers that comprise ethylene monomers and at least one monomer (sometimes referred to herein as a comonomer) of vinyl acetate, a vinyl ester, an acrylate, methyl acrylate, ethyl acrylate, n-butyl acrylate, ethyl methacrylate, acrylic acid, methacrylic acid, neutralized or partially neutralized salts of an acrylic acid, carbon monoxide, propylene, 1-butene, 1-pentene, 1-hexene, 1-heptene, 1-octene, 4-methyl-1-pentene, any derivative thereof, any suitable salt thereof (full or partial, e.g., where only some of the comonomers are in salt form and others in acid form), and any combination thereof. As used herein, the term “copolymer” encompass polymers with two or more monomeric units, e.g., alternating copolymers, statistic copolymers, random copolymers, periodic copolymers, block copolymer (e.g., diblock, triblock, and so on), terpolymers, graft copolymers, branched copolymers, star polymers, and the like, or any hybrid thereof.

Ethylene copolymers comprising ethylene monomers and vinyl acetate monomers may have a structure according to Formula I, wherein X and Y may independently be hydrogen or a C₁-C₁₀ alkyl group that may be linear or branched and saturated or unsaturated. Further, the monomers may be arranged according to any copolymer structure described herein.

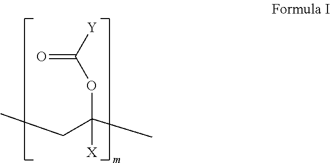

Ethylene copolymers comprising ethylene monomers and acrylates and/or acid monomers may have a structure according to Formula II (or salts thereof), wherein X and Y may independently be hydrogen or a C₁-C₁₀ alkyl group that may be linear or branched and saturated or unsaturated. Further, the monomers may be arranged according to any copolymer structure described herein.

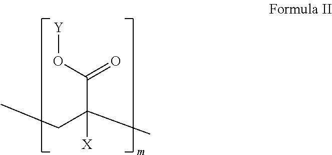

In the case of ethylene copolymers, several characteristics of the copolymers may be tailored to achieve a desired diffusion rate, which as described below effects the release rate, of insect repellents and optionally insect repellent synergists. Suitable characteristics may include, but are not limited to, crystallinity, comonomer content, architecture (e.g., the number of internal segments per chain and the Kuhn length), polarity, or any combination thereof. Further, the diffusion rate may, in some embodiments, be tailored by the use of an additional polymer with the ethylene copolymers. Suitable examples of additional polymers are discussed in more detail below.

Suitable ethylene copolymers for use in conjunction with the present invention may have a crystallinity ranging from a lower limit of about 0%, 5%, or 10% to an upper limit of about 60%, 50%, or 40% measured by differential scanning calorimetry in the method provided below, and wherein crystallinity from any lower limit to any upper limit and encompasses any subset therebetween. Suitable ethylene vinyl acetate copolymers for use in conjunction with the present invention may have a crystallinity ranging from a lower limit of about 0%, 5%, or 10% to an upper limit of about 60%, 50%, or 40% measured by differential scanning calorimetry in the method provided below, and wherein crystallinity from any lower limit to any upper limit and encompasses any subset therebetween. Suitable methods for differential scanning calorimetry to determine crystallinity may include ASTM 3418 or IS011357 with scanning rates of 10° C./min, an annealing temperature of 160° C., and an annealing time of 10 minutes. By way of nonlimiting example, an ethylene copolymer may be heated to 160° C. at a ramp rate of 10° C./min, held at 160° C. for 10 minutes, cooled to 0° C. at a rate of 10° C./min, and finally heated above the melting temperature (e.g., to 160° C.) at a ramp rate of 10° C./min, where the crystallinity relates to the heat required to melt the ethylene copolymer relative to the heat required to melt polyethylene. Several factors affect the crystallinity of ethylene copolymers including, but not limited to, the comonomer content, the thermal history, the molecular weight, and the polymer architecture.

Suitable ethylene copolymers for use in conjunction with the present invention may have a comonomer content ranging from a lower limit of greater than 0%, about 1%, about 10%, or about 25% to an upper limit of about 90%, 75%, or 50%, and wherein the comonomer content of the copolymer may range from any lower limit to any upper limit and encompass any subset therebetween. Suitable ethylene vinyl acetate copolymers for use in conjunction with the present invention may have a vinyl acetate content ranging from a lower limit of greater than 0%, about 1%, about 10%, or about 25% to an upper limit of about 90%, 75%, or 50%, and wherein the vinyl acetate content of the copolymer may range from any lower limit to any upper limit and encompass any subset therebetween. In some embodiments, ethylene copolymers for use in conjunction with the present invention can be a blend of two or more ethylene copolymers having the same comonomer but different comonomer contents, e.g., a blend of a first ethylene vinyl acetate having a vinyl acetate content of about 5% to about 15% and a second ethylene vinyl acetate having a finyl acetate content of about 20% to about 35%.

Suitable ethylene copolymers for use in conjunction with the present invention may have a number of internal segments per chain ranging from a lower limit of about 0.1, 1, or 5 to an upper limit of about 50, 25, or 10, and wherein the number of internal segments per chain may range from any lower limit to any upper limit and encompass any subset therebetween. Suitable ethylene vinyl acetate copolymers for use in conjunction with the present invention may have a number of internal segments per chain ranging from a lower limit of about 0.1, 1, or 5 to an upper limit of about 50, 25, or 10, and wherein the number of internal segments per chain may range from any lower limit to any upper limit and encompass any subset therebetween.

Suitable ethylene copolymers for use in conjunction with the present invention may have a Kuhn length ranging from a lower limit of about 5 Å or 10 Å to an upper limit of about 30 Å or 20 Å, and wherein the Kuhn length may range from any lower limit to any upper limit and encompass any subset therebetween. Suitable ethylene vinyl acetate copolymers for use in conjunction with the present invention may have a Kuhn length ranging from a lower limit of about 5 Å or 10 Å to an upper limit of about 30 Å or 20 Å, and wherein the Kuhn length may range from any lower limit to any upper limit and encompass any subset therebetween.

Suitable ethylene copolymers for use in conjunction with the present invention may have a Van Krevelen solubility parameter value ranging from a lower limit of about 8,380 J/mol to an upper limit of about 31,080 J/mol, and wherein the Van Krevelen solubility parameter value may range from any lower limit to any upper limit and encompass any subset therebetween. Suitable ethylene vinyl acetate copolymers for use in conjunction with the present invention may have a Van Krevelen solubility parameter value ranging from a lower limit of about 8,380 J/mol to an upper limit of about 31,080 J/mol, and wherein the Van Krevelen solubility parameter value may range from any lower limit to any upper limit and encompass any subset therebetween.

As described below, the relative Van Krevelen solubility parameter value between an ethylene copolymer (optionally including an additional polymer) and an insect repellent (or optionally an insect repellent synergist or optionally an additive) may affect the release rate and efficacy timeframe of a CRIRM of the present invention, or articles or products produced therefrom. In some embodiments, a CRIRM of the present invention may comprise ethylene copolymers and an insect repellent having relative Van Krevelen solubility parameter values within about 5% or less. In some embodiments, a CRIRM of the present invention may comprise ethylene copolymers and an insect repellent having relative Van Krevelen solubility parameter values within about 5% to about 15%. In some embodiments, a CRIRM of the present invention may comprise ethylene vinyl acetate copolymers and an insect repellent having relative Van Krevelen solubility parameter values within about 5% or less. In some embodiments, a CRIRM of the present invention may comprise ethylene vinyl acetate copolymers and an insect repellent having relative Van Krevelen solubility parameter values within about 5% to about 15%.

In some embodiments, a CRIRM of the present invention may further comprise at least one additional polymer. Suitable additional polymers may be thermoplastic polymers including, but not limited to, poly(methyl methacrylate), poly(vinyl chloride), poly(vinylidene fluoride), polydimethylsiloxane, polyvinylbutyral, polyolefin plastomers, polyolefin elastomers, olefinic block copolymers, polyurethanes, ultrahigh molecular weight polyethylenes, very high molecular weight polyethylenes, high molecular weight polyethylenes, low molecular weight polyethylenes, polyolefins, polyesters, polyamides, nylons, polyacrylics, polystyrenes, polyvinyls, polytetrafluoroethylenes, polyether ether ketones, non-fibrous plasticized celluloses, polyethylenes, polypropylenes, polybutylenes, polymethylpentenes, low-density polyethylenes, linear low-density polyethylenes, high-density polyethylenes, polyethylene terephthalates, polybutylene terephthalates, polycyclohexylene dimethylene terephthalates, polytrimethylene terephthalates, polystyrenes, acrylonitrile-butadiene-styrenes, styrene-acrylonitriles, styrene-butadienes, styrene-maleic anhydrides, polyvinyl chlorides, acrylates, cellulose acetates, cellulose acetate butyrates, plasticized cellulosics, cellulose propionates, ethyl celluloses, and the like, any derivative thereof, any blend polymer thereof, any copolymer thereof, or any combination thereof. By way of nonlimiting example, a CRIRM of the present invention may include ethylene vinyl acetate copolymer, low molecular weight polyethylene, and insect repellent, and optionally an insect repellent synergist.

In some embodiments, a CRIRM of the present invention may include an additional polymer in an amount ranging from a lower limit of about 0.1%, 1%, 10%, or 25% by weight of the CRIRM to an upper limit of about 75%, 50%, or 25% by weight of the CRIRM, and wherein the amount of additional polymer may range from any lower limit to any upper limit and encompass any subset therebetween. In some embodiments, the additional polymer may be included as a blend polymer.

In some embodiments, a CRIRM of the present invention may optionally further comprise additives. Suitable additives for use in conjunction with the present invention may include, but not be limited to, active particles, active compounds, ion exchange resins, superabsorbent polymers, zeolites, nanoparticles, ceramic particles, abrasive particulates, absorbent particulates, softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof. Some additives are discussed in more detail below. By way of nonlimiting example, an aroma may be used to mask the smell of some insect repellents. By way of another nonlimiting example, vitamins, e.g., those with antioxidant properties, may help stabilize a CRIRM of the present invention, e.g., act to absorb free radicals produced in long-term exposure to sunlight that may react with an insect repellent. By way of yet another nonlimiting example, biocides, antifungal, or antimicrobial may be included to affect the bacteria and the like so as to make it toxic to an insect of interest that feeds on the bacteria, which may provide further insect repellent/insecticide benefits once the insect repellent efficacy is lessened and insects begin to return. By way of another nonlimiting example, conductivity modifying additives may be included to enhance the heat conductivity of a CRIRM of the present invention, which may assist in the diffusion or evaporation of higher molecular weight insect repellents.

One skilled in the art with the benefit of this disclosure should understand that the specific additive and concentration thereof should be chosen so as not to affect the operability of the CRIRM of the present invention. By way of nonlimiting example, some peroxides may react with some insect repellents described herein. Therefore, such peroxide/insect repellent combinations should either be avoided or formulated such that the concentration of the peroxide is low.

In some embodiments, a CRIRM of the present invention may include an additive in an amount ranging from a lower limit of about 0.01%, 0.1%, 1%, or 5% by weight of the CRIRM to an upper limit of about 25%, 10%, or 5% by weight of the CRIRM, and wherein the amount of an additive may range from any lower limit to any upper limit and encompass any subset therebetween. By way of nonlimiting example, antioxidants may be included in CRIRM of the present invention in amounts ranging from about 0.01% to about 0.1%.

In some embodiments, an insect repellent, an insect repellent synergist, and/or an additive for use in conjunction with the present invention may be in the form of a liquid, a solid, dispersed in a solvent, a solid encapsulated by a polymer and/or surfactant, an emulsion, a stabilized emulsion, a microemulsion, or any combination thereof. In some embodiments, it may be advantageous for an insect repellent, an insect repellent synergist, and/or an additive to be in the form of a solid encapsulated by a polymer and/or surfactant, an emulsion, a stabilized emulsion, or a microemulsion. These forms may advantageously provide a barrier to an insect repellent, an insect repellent synergist, and/or an additive immediately integrating into the polymer matrix (e.g., ethylene copolymers, ethyl celluloses, thermoplastic polyurethanes, and optional additional polymers), which prolong the release rate of the insect repellent, the insect repellent synergist, and/or the additive.

A CRIRM of the present invention may be used in a variety of physical forms. Suitable physical forms include, but are not limited to, articles (described further below), fibers, sheets, pellets, particles, and the like. In some embodiments, a CRIRM of the present invention may be at least a portion of an article, as described below. By way of nonlimiting example, a CRIRM fiber may be used in the production of a nonwoven fabric. By way of another nonlimiting example, a CRIRM in article form may be a molded article, like a bottle, a bucket, or a candle-shape, where the molded article may consist essentially of a CRIRM. It should be noted, that when referring to the form of a CRIRM of the present invention, the polymer matrix (e.g., ethylene copolymers, ethyl celluloses, thermoplastic polyurethanes, and optional additional polymers) provides the structure.

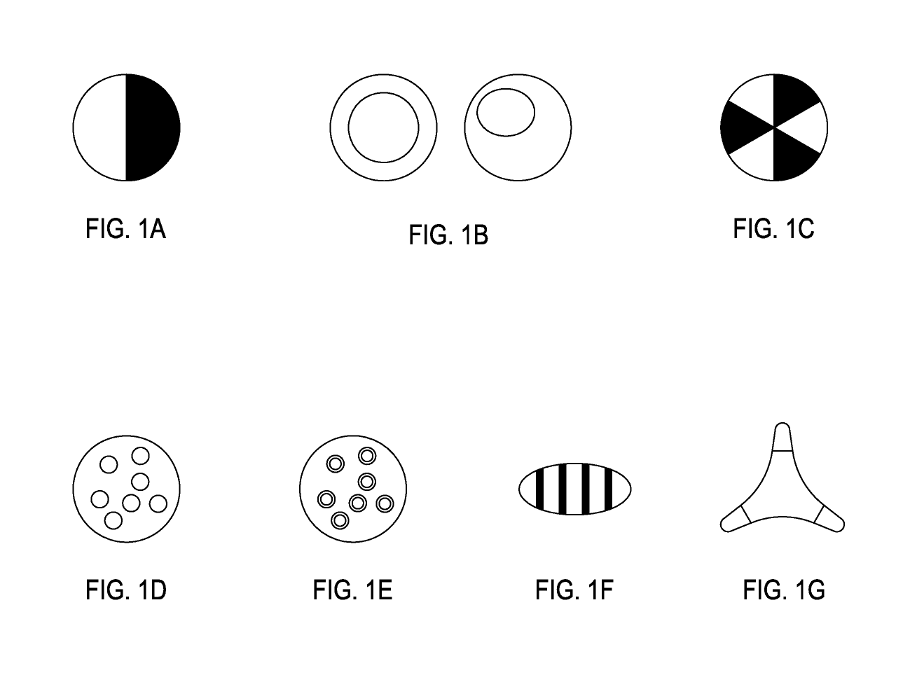

Suitable fiber forms of a CRIRM of the present invention may include, but are not limited to, bicomponent fibers, un-oriented fibers, oriented fibers, nanofibers, or any hybrid thereof. Suitable configurations for bicomponent fiber forms (nonlimiting examples illustrated in FIGS. 1A-G) of the CRIRM with the present invention may include, but are not limited to, side-by-side (FIG. 1A), sheath-core (FIG. 1B), segmented-pie (FIG. 1C), islands-in-the-sea (FIG. 1D), bicomponent islands (FIG. 1E), tipped (FIG. 1F), segmented-ribbon (FIG. 1G), or any hybrid thereof.

Suitable cross-sectional shapes for fiber forms of the CRIRM of the present invention may include, but are not limited to, circular, substantially circular, crenulated, ovular, substantially ovular, ribboned, polygonal, substantially polygonal, dog-bone, “Y,” “X,” “K,” “C,” multi-lobe, and any hybrid thereof. As used herein, the term “multi-lobe” refers to a cross-sectional shape having a point (not necessarily in the center of the cross-section) from which at least two lobes extend (not necessarily evenly spaced or evenly sized).

In some embodiments, fiber forms of a CRIRM of the present invention may have an average fiber diameter ranging from a lower limit of about 100 nm, 250 nm, 500 nm, 1 micron, or 10 microns to an upper limit of about 50 microns, 25 microns, 10 microns, 5 microns, or 1 micron, wherein the average diameter may range from any lower limit to any upper limit and encompass any subset therebetween. By way of nonlimiting example, a CRIRM in a fiber form for use in netting applications as described below may have an average fiber diameter ranging from about 5 microns to about 15 microns.

As used herein, the term “sheet” refers generally to a sheet-like structure, which includes thin films and nano films, and is not limited by thickness. For clarity as used herein, the term “sheet” refers to a CRIRM in a sheet-like form, while the term “film,” as described below, refers to an article. It should be noted that, as described below, a CRIRM of the present invention in the form of a sheet may, in some embodiments, be an article that is a film.

Suitable sheet forms of a CRIRM of the present invention may have a thickness ranging from a lower limit of about 5 microns, 10 microns, 50 microns, 100 microns, 500 microns, or 1 mm to an upper limit of about 1 cm, 5 mm, 2 mm, 1 mm, 750 microns, 500 microns, or 250 microns, and wherein the thickness may range from any lower limit to any upper limit and encompass any subset therebetween.

In some embodiments, a CRIRM of the present invention may be any suitable form described above and comprise a polymer (e.g., ethylene copolymers, ethyl celluloses, thermoplastic polyurethanes, and an optional additional polymer) according to any characteristics and compositions described above and at least one insect repellent including those described above. Further, in some embodiments, a CRIRM of the present invention may further comprise at least one insect synergist including those described above, at least one additive including those described above, at least one additional polymer including those described above, or any combination thereof. Further, in some embodiments a CRIRM of the present invention may include any of the aforementioned components in a desired form and at a desired concentration according to any of the embodiments described above.

### II. Producing Controlled Release Insect Repellent Materials

Producing a CRIRM of the present invention may generally involve, in some embodiments, producing a polymer melt comprising polymers (e.g., ethylene copolymers, ethyl celluloses, thermoplastic polyurethanes, and an optional additional polymer) and an insect repellent, and then forming the polymer melt into a desired form of a CRIRM of the present invention. Further, in some embodiments, insect synergists, additives, additional polymers, or any combination thereof may be included in the polymer melt.

In some embodiments, producing a polymer melt comprising insect repellent and polymers (e.g., ethylene copolymers, ethyl celluloses, thermoplastic polyurethanes, and an optional additional polymer) may involve producing a polymer melt comprising the polymer and admixing insect repellent therein. In some embodiments, producing a polymer melt comprising an insect repellent and polymers (e.g., ethylene copolymers, ethyl celluloses, thermoplastic polyurethanes, and an optional additional polymer) may involve absorbing the insect repellent into the polymer, and then producing a polymer melt from the polymer having the insect repellent absorbed therein.

In some embodiments, producing a polymer melt comprising insect repellent and polymers (e.g., ethylene copolymers, ethyl celluloses, thermoplastic polyurethanes, and an optional additional polymer) may involve absorbing an insect repellent into an additional polymer, and then producing a polymer melt from the polymer and the additional polymer having the insect repellent absorbed therein.

Additional optional components (e.g., insect repellent synergists, additives, and additional polymers) may be, in some embodiments, incorporated at any suitable point in any of the aforementioned methods. Insect repellent synergists and additives that are miscible in the polymers (e.g., ethylene copolymers, ethyl celluloses, thermoplastic polyurethanes, and an optional additional polymer) may, in some embodiments, be absorbed therein before formation of the polymer melt as described for an insect repellent in the aforementioned methods.

In some embodiments, producing a polymer melt comprising insect repellents, polymers (e.g., ethylene copolymers, ethyl celluloses, thermoplastic polyurethanes, and an optional additional polymer), optional insect synergists, optional additives, and optional additional polymers may be a hybrid or combination of one of the aforementioned methods.

A polymer melt comprising polymers (e.g., ethylene copolymers, ethyl celluloses, thermoplastic polyurethanes, and an optional additional polymer) and an insect repellent may, in some embodiments, be formed into a CRIRM of the present invention in a desired physical form, e.g., articles, fibers, sheets, pellets, and the like. Suitable forming techniques may include, but are not limited to, extruding, casting, compression molding, blow molding, and the like. It should be noted that extruding includes, but is not limited to, extruding methods that include extrusion through dies which may optionally use high-velocity air flow (e.g., to draw thinner sheets or melt spinning to draw finer fibers) and/or optionally use electric charge (e.g., electrospinning to draw finer fibers).

Producing a CRIRM of the present invention may generally involve, in some embodiments, extruding a polymer melt comprising polymers (e.g., ethylene copolymers, ethyl celluloses, thermoplastic polyurethanes, and an optional additional polymer) to form an extrudate in a desired physical form and then absorbing an insect repellent into the extrudate. Further, in some embodiments, an insect repellent synergist and/or an additive may be absorbed into the extrudate after formation.

In some embodiments, producing a CRIRM of the present invention may involve a combination of any of the aforementioned methods, that is, an insect repellent, an insect repellent synergist, and an additive may each independently be incorporated by inclusion in the polymer melt or by absorption after an extrudate is formed. By way of nonlimiting example, a polymer melt may comprise ethylene copolymers, an additional polymer, and insect repellent synergist; and an insect repellent may be absorbed into the extrudate. By way of another nonlimiting example, a polymer melt may comprise ethylene copolymers and an additive; and an insect repellent and an insect repellent synergist may be absorbed into the extrudate. By way of yet another nonlimiting example, a polymer melt may comprise ethylene copolymers and an insect repellent; and an additive may be absorbed into the extrudate.

In some embodiments, absorption of an insect repellent, an insect repellent synergist, and/or an additive, in conjunction with any of the aforementioned methods, may include the use of a solvent having an insect repellent, an insect repellent synergist, and/or an additive dispersed therein. It should be noted that the term “dispersed” includes a degree of dispersion including dissolved.

Use of a solvent, may advantageously, inter alia, increase the rate of absorption, provide for selective absorption into the ethylene copolymers, ethyl celluloses, and/or thermoplastic polyurethanes versus an additional polymer, or allow for absorption of an insect repellent, an insect repellent synergist, and/or an additive that is not a free-flowing liquid at room temperature. By way of nonlimiting example, an absorbable component may be dispersed in a solvent and then absorbed selectively into the sheath of the bicomponent fiber having a core/sheath configuration, where the sheath of the bicomponent fiber is miscible with a solvent in the core is not.

In some embodiments where a solvent is used in absorption, the solvent may be removed from the CRIRM of the present invention by, for example, evaporation, which may be assisted by enhanced airflow and/or heat.

In some embodiments that involve absorption of an insect repellent, an insect repellent synergist, an additive, or any combination thereof (with or without a solvent), the extrudate may be immediately treated; cooled and then treated; cooled, stored, and then treated; or any combination thereof. In some embodiments, the extrudate may be treated more than once with an insect repellent, an insect repellent synergist, an additive, or any combination thereof so as to achieve a desired CRIRM of the present invention, where each treatment may be with the same or different insect repellents, insect repellent synergists, additives, or combinations thereof. Suitable treatments to affect absorption of an insect repellent, an insect repellent synergist, an additive, or any combination thereof may include, but are not limited to, dipping, soaking, spraying, painting, washing, and the like, or any combination thereof.

In some embodiments, an insect repellent synergist, an additive, or any combination thereof may be applied to a surface and then a polymer melt may be extruded onto the surface, where the polymer melt may be formed according to the any aforementioned methods. In some embodiments, the surface may be the same or similar composition as the polymer melt. By way of nonlimiting example, an insect repellent may be applied to the surface of a sheet comprising ethylene copolymers, and then a polymer melt comprising ethylene copolymers may be extruded onto the sheet so as to “sandwich” the insect repellent between two sheets comprising ethylene copolymers (e.g., ethylene vinyl acetate copolymers). In some instances, the sheets with insect repellent therebetween may be different polymers (e.g., ethylene copolymers, ethyl celluloses, thermoplastic polyurethanes, and an optional additional polymer). For example, the two sheets may be ethylene copolymers with different comonomer contents.

Some embodiments of the present invention may involve producing particles of CRIRM of the present invention. Production of CRIRM particles may be achieved by several methods. For example, in some embodiments, a CRIRM of the present invention in the form of a sheet, pellets, fibers, or the like may be mechanically broken down into particles. In some embodiments, mechanically breaking down a CRIRM into particles may involve crushing, shredding, milling, or any combination thereof. In some embodiments, mechanically breaking down the CRIRM into particles may involve cooling (e.g., freezing or cryogenically cooling) the CRIRM before and/or during mechanical breakdown.

In some embodiments, a CRIRM of the present invention in particle form may have a size in at least one dimension ranging from a lower limit of about 10 nm, 100 nm, 1 micron, or 10 microns to an upper limit of about 1 mm, 500 microns, 100 microns, 10 microns, or 1 micron, were the size of the particles may have at least one dimension ranging from any lower limit to any upper limit and encompass any subset therebetween. By way of nonlimiting example, a plurality of CRIRM of the present invention in particle form having at least one dimension of about 50 nm may be included in an insect repellent spray, where the size of the CRIRM may enable the CRIRM to be aerosolized.

### III. Articles and Products Comprising Controlled Release Insect Repellent Materials and Methods Relating Thereto

Some embodiments of the present invention may involve producing articles and/or products comprising at least one CRIRM of the present invention. Examples of articles may include, but are not limited to, films, layered articles, woven fabrics, nonwoven fabrics, knit fabrics, yarns, molded articles, and the like, or any combination thereof.

As used herein, the term “film” refers to a single layer article. In some embodiments, a film may comprise a CRIRM of the present invention. In some embodiments, a film may be a CRIRM of the present invention in a sheet form. In some embodiments, a film may comprise a matrix material and a CRIRM of the present invention. By way of nonlimiting example, a film may be a single layer of polyurethane comprising a CRIRM of the present invention in particulate form.

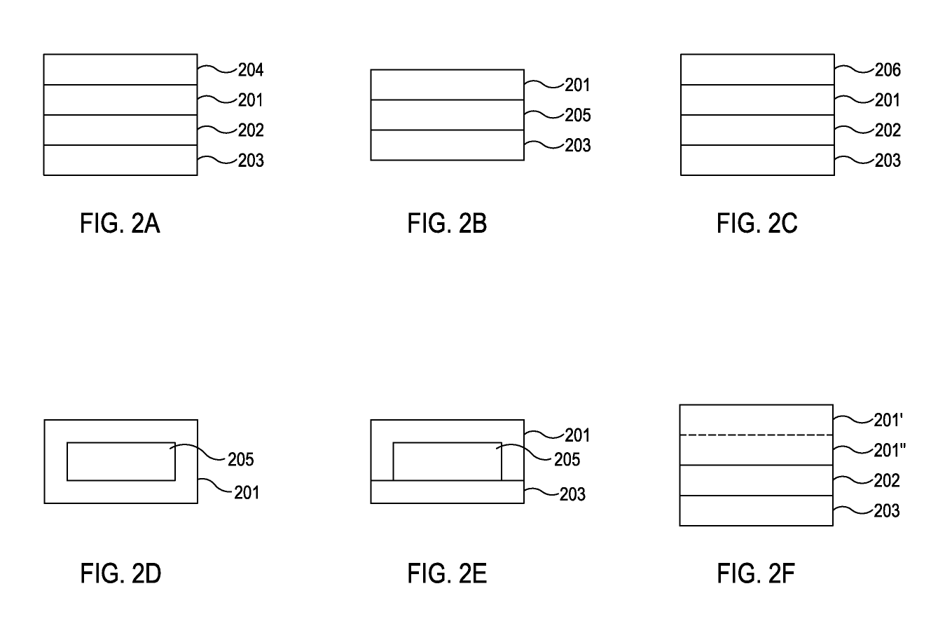

In some embodiments, a layered article may comprise a CRIRM of the present invention. Generally, such a layered article may comprise at least two layers with at least one layer being an insect repellent layer comprising a CRIRM of the present invention. Suitable additional layers may include, but are not limited to, adhesive layers, backing layers, release modulation layers, structural layers, peelable layers, and the like, or any combination thereof. It should also be noted that the terms “layers,” “films,” “coatings,” and the like do not necessarily indicate an absolute thickness or relative thickness. For example, layers may have holes, e.g., webs, nets, lattices, grids, discontinuous layers (e.g., lightly sprayed on adhesives), and the like. Further, the terms “layers,” “films,” “coatings,” and the like do not necessarily indicate a specific shape, that is, these terms are not limited to flat sheets. For example, a layer may have an eye-shaped cross-section, and some layers may be disposed about other layers as illustrated in FIG. 2D described below. In some embodiments, layered articles may comprise two layers joined with at least about a portion of a third layer disposed therebetween, for example, as illustrated in FIG. 2E described below.

Nonlimiting examples of configurations for layered articles are illustrative in FIGS. 2A-F. In the nonlimiting example illustrated in FIG. 2A, the layered article includes, in order, release modulation layer 204, insect repellent layer 201, backing layer 202, and adhesive layer 203. In the nonlimiting example illustrated in FIG. 2B, the layered article includes, in order, insect repellent layer 201, structural layer 205, and adhesive layer 203. In the nonlimiting example illustrated in FIG. 2C, the layered article includes, in order, peelable layer 206, insect repellent layer 201, backing layer 202, and adhesive layer 203. In the nonlimiting example illustrated in FIG. 2D, the layered article includes insect repellent layer 201 disposed about structural layer 205. In the nonlimiting example illustrated in FIG. 2E, the layered article includes structural layer 205 disposed between insect repellent layer 201 and adhesive layer 203 such that insect repellent layer 201 and adhesive layer 203 are in contact by extending beyond the size of structural layer 205. In the nonlimiting example illustrated in FIG. 2F, the layered article includes, in order, a first insect repellent layer 201′, a second insect repellent layer 201″, backing layer 202, and adhesive layer 203.

Suitable adhesives for use in conjunction with the present invention may include, but are not limited to, pressure sensitive adhesives, glue, gelatin, caesin, starch, cellulose esters, aliphatic polyesters, poly(alkanoates), aliphatic-aromatic polyesters, sulfonated aliphatic-aromatic polyesters, polyamide esters, rosin/polycaprolactone triblock copolymers, rosin/poly(ethylene adipate) triblock copolymers, rosin/poly(ethylene succinate) triblock copolymers, poly(vinyl acetates), poly(ethylene-co-ethylacrylate), poly(ethylene-co-methyl acrylate), poly(ethylene-co-propylene), poly(ethylene-co-1-butene), poly(ethylene-co-1-pentene), poly(styrene), acrylics, polyurethanes, sulfonated polyester urethane dispersions, nonsulfonated urethane dispersions, urethane-styrene polymer dispersions, non-ionic polyester urethane dispersions, acrylic dispersions, silanated anionic acrylate-styrene polymer dispersions, anionic acrylate-styrene dispersions, anionic acrylate-styrene-acrylonitrile dispersions, acrylate-acrylonitrile dispersions, vinylchloride-ethylene emulsions, vinylpyrrolidone/styrene copolymer emulsions, carboxylated and noncarboxylated vinyl acetate ethylene dispersions, vinyl acetate homopolymer dispersions, polyvinyl chloride emulsions, polyvinylidene fluoride dispersions, ethylene acrylic acid dispersions, polyamide dispersions, anionic carboxylated or noncarboxylated acrylonitrile-butadiene-styrene emulsions and acrylonitrile emulsions, resin dispersions derived from styrene, resin dispersions derived from aliphatic and/or aromatic hydrocarbons, styrene-maleic anhydrides, gamma-chloropropylmethoxysilane, vinyltrichlorosilane, vinyltriethoxysilane, vinyltris(beta-methoxyethoxy)silane, gamma-methacryloxypropyltrimethoxysilane, beta-(3,4-epoxycyclohexyl)ethyltrimethoxysilane, gammaglycidoxypropyltrimethoxysilane, vinyl-triacetoxysilane, gamma-mercaptopropyltrimethoxysilane, gamma-aminopropyltriethoxysilane, N-beta-(aminoethyl)-gamma-aminopropyl-trimethoxysilane, and the like, or any combination thereof. Said adhesives may be applied through melt processes or through solution, emulsion, dispersion, or other suitable coating processes.

Generally, backing layers for use in conjunction with the present invention may prevent liquids from passing therethrough. For example in countertop surface films, the backing layer may prevent passage of liquids, e.g., milk or cola, through the film to the countertop surface. Suitable backing layers for use in conjunction with the present invention may include, but are not limited to, thin polymer films of hydrophobic polymers like polypropylene and polyethylene. By way of nonlimiting example, a backsheet for use in conjunction with the present invention may comprise a layer of polyethylene film having a basis weight between about 10 g/m² and about 30 g/m², although other flexible, liquid impervious materials can be used.

In some embodiments, backing layers for use in conjunction with the present invention may be breathable (e.g., via micropores) so as to permit vapors to escape or pass therethrough while still preventing fluids from passing therethrough. In some embodiments, backing layers for use in conjunction with the present invention may have a nonwoven laminated to the film layer so as to make backing layers more “cloth-like.” Such a nonwoven layer may, in some embodiments, comprise a nonwoven material (e.g., one having a spunbonded or other suitable structure) with a basis weight between about 15 g/m² and about 25 g/m².

Generally, release modulation layers for use in conjunction with the present invention are designed to have little or no insect repellent therein and may further assist with the controlled release of insect repellents from an insect repellent layer, described in more detail below. For example, an insect repellent layer may have disposed thereon a release modulation layer such that the insect repellent layer acts as a pseudo-reservoir for the insect repellent. Because the insect repellent layer modulates to some degree the concentration at the interface with the release modulation layer the two layers may synergistically provide for a desired release rate. Suitable release modulation layers may include, but are not limited to, polymeric materials through which a given insect repellent may traverse at a slower rate than the polymeric materials of the corresponding insect repellent layer. Specific examples of release modulation layer materials may include, but are not limited to, ethylene vinyl acetate copolymer, silicon-based organic polymers (e.g., polydimethylsiloxane), polyurethanes, latex wrappers, polyamides, polyesters, polytetrafluoroethylene, nylon, and the like, any blend thereof, or any combination thereof. By way of nonlimiting example, an insect repellent layer may comprise ethylene vinyl acetate copolymer having a crystallinity of about 25% and a release modulation layer used in conjunction with the insect repellent layer may comprise ethylene vinyl acetate copolymer having a crystallinity of about 40%. By way of another nonlimiting example, an article may comprise a series of layers that comprise ethylene vinyl acetate copolymer having an average crystallinity of about 40%. By way of yet another nonlimiting example, an insect repellent layer comprising ethylene vinyl acetate copolymer may be used in conjunction with a release modulation layer comprising polyethylene or a polyethylene-based copolymer.

Suitable release modulation layers may have a thickness ranging from a lower limit of about 1 micron, 10 microns, or 25 microns to an upper limit of about 100 microns, 75 microns, or 50 microns, and wherein the thickness may range from any lower limit to any upper limit and encompass any subset therebetween.

Generally, structural layers for use in conjunction with the present invention provide structural stability for the layered article and may be flexible or rigid. For example, a layered article may comprise an insect repellent layer, a structural layer being a mesh, and an adhesive such that the mesh provides for a layered article that can be reshaped and hold the new shape. Suitable materials that may be used as at least a portion of a structural layer may include, but are not limited to, metals, ceramics, polymers, polymer composites, and the like, or any combination thereof. Suitable forms for a structural layer may include, but are not limited to, a mesh, a plate, a thin-film, a rod, or any hybrid thereof. It should be noted that structural layers may have backing layer characteristics, i.e., being substantially impermeable to liquids.

Generally, peelable layers for use in conjunction with the present invention provide peelable seals for protecting adjacent layers and minimizing release of insect repellents prior to a desired time of use. For example, the peelable layer could be a blend of two incompatible polymers, where the incompatibility of these polymers would sufficiently weaken this layer to allow it to fail cohesively when the film is pulled apart. One example of such a layer would be a blend of polybutene and ethylene vinyl acetate copolymer. In some embodiments, peelable layers may comprise insect repellents and/or insect repellent synergists, so as to deliver a burst of the insect repellents and/or insect repellent synergists when the peelable layer is first removed.

Some embodiments of the present invention may involve producing layered articles that comprise at least one insect repellent layer. Suitable methods of producing layered articles may include, but are not limited to, extruding, coextruding, extrusion coating, casting, laminating, compression molding, blow molding, calendaring, hydroentangling, sewing, adhering, and the like, any hybrid thereof, or any combination thereof.

In some embodiments, a fabric (e.g., woven fabric, nonwoven fabric, or knit fabric) may comprise a CRIRM of the present invention. Generally, fabrics may comprise a CRIRM of the present invention in two ways. First, the CRIRM of the present invention may, in some embodiments, be in a fiber form which is then used in the production of the fabric, where the fabric may optionally comprise fibers of other materials (e.g., polyethylene fibers, polypropylene fibers, cellulose acetate fibers, and the like). By way of nonlimiting example, a CRIRM of the present invention may be bicomponent fibers used to produce fabrics. Second, a CRIRM of the present invention may, in some embodiments, be an additive to the fabric. By way of nonlimiting example, a CRIRM of the present invention in particulate form may be adhered to individual fibers of the fabric.

In some embodiments, a fabric may be one layer of a layered article, where the fabric and/or another layer of the layered article comprises a CRIRM of the present invention. By way of nonlimiting example, a CRIRM of the present invention in sheet form may be applied to (e.g., with an adhesive) a nonwoven fabric.

Suitable methods of forming a nonwoven fabric may include, but are not limited to, carding methods, meltblown methods, spunbond methods, electrospun methods, and the like.

In some embodiments, a molded article may comprise a CRIRM of the present invention. In some embodiments, a CRIRM of the present invention may be molded to form a molded article. By way of nonlimiting example, a CRIRM of the present invention in sheet form with a 1 mm thickness may be thermally molded to form a container like a bowl or a cup for outdoor use.

In some embodiments, a molded article may comprise a matrix material and at least one CRIRM of the present invention. By way of nonlimiting example, a molded article may comprise polyethylene terephthalate with a CRIRM of the present invention in fiber form dispersed therethrough.

In some embodiments, a molded article may be one layer of a later article, where the molded article and/or another layer of the layered article comprises a CRIRM of the present invention. By way of nonlimiting example, a plastic planter may have a CRIRM of the present invention in sheet form applied to the outer surface (e.g., with an adhesive).

In some embodiments, a CRIRM of the present invention in particle form may be incorporated into a delivery vehicle. Suitable delivery vehicles may include, but are not limited to, a fluid, a pressurized fluid, a coating fluid, a lotion, a cream, or any combination thereof. Incorporation of a CRIRM of the present invention in particle form into a delivery vehicle may advantageously provide for medium-term to longer-term release of the insect repellent therein while being able to be dispersed over a larger area. One skilled in the art, with the benefit of this disclosure, should understand that such dispersion will increase the total surface area of the CRIRM, and therefore may increase the release rate. To combat such issues, the polymers (e.g., ethylene copolymers, ethyl celluloses, thermoplastic polyurethanes, and an optional additional polymer) of the CRIRM may be modified to provide longer release rates when taking into consideration the increased surface area.

Some embodiments may involve producing products that comprise a CRIRM of the present invention. In some embodiments, the production of such products may be from a CRIRM of the present invention and/or from articles comprising a CRIRM of the present invention. Nonlimiting examples of products that may comprise a CRIRM of the present invention may include clothing and/or jewelry (e.g., socks, foam sandals, hats, handkerchiefs, bandannas, necklaces, rubber bracelets, or ponchos), shoe inserts (e.g., liners, counterliners, interliners, or reinforcing materials), sporting fabrics (e.g., wristbands, headbands, or Velcro-bands (e.g., a hook-and-loop fastener)), personal care wipes (e.g., antibacterial wipes, sweat wipes, or handkerchiefs), other fabrics (e.g., baby stroller fabrics), outdoor products (e.g., mosquito nets, planters, patio furniture, outdoor tableware, outdoor decorations, tiki torches, camping equipment, tents, folding chairs, seat cushions, or portable seat cushions), surface coverings (e.g., wallpaper, television or computer screen films, countertop films, window films, tinted window films, and light fixture finishing films), furniture textiles (e.g., upholstery, bedware, quilted products, and furniture stuffings), construction products (e.g., weather strips, insulation, or house wrappings), insulation products (e.g., for homes, clothing, packs, vehicles, textiles, or noise damping in ceilings and walls), vehicle interiors (e.g., headliners, trunkliners, door trim, package trays, sunvisors, or seats), Velcro straps (e.g., hook-and-loop fastener), horticulture products (e.g., plant coverings and flower bed liners), composite materials (e.g., glass-fiber-reinforced plastics), consumer products (personal insect repellent patches, personal insect repellent devices, plug-in insect repellent devices, electronic insect repellent devices, insect repellent candles, flameless insect repellent candles, and fans), personal care products (e.g., lotions and creams), pet products (e.g., collars, cages or pins, leashes, toys, or urine pads), window treatments, the inside layer of tufted carpets and carpet tiles, carpet backings, containers (e.g., bags), disposable medical products (e.g., bandages and band-aids), fluid insect repellent products (e.g., sprays, aerosols, and paints), and the like.

By way of nonlimiting example, the cloth upholstery of patio furniture may comprise cotton fibers and CRIRM of the present invention in fiber form.

By way of another nonlimiting example, an outdoor vinyl tablecloth may be produced from a polymer melt comprising polyvinyl chloride, ethylene vinyl acetate copolymer, and insect repellent.

By way of yet another nonlimiting example, a tinted window film may comprise layers of an adhesive and a CRIRM of the present invention.

By way of another nonlimiting example, an outdoor carpet may comprise in its backing CRIRM of the present invention in fiber form.

By way of yet another nonlimiting example, a CRIRM of the present invention in particulate form with at least one dimension of about 1 micron or less may be incorporated into an outdoor spray.

By way of another nonlimiting example, a poncho may be made from nonwoven fabric comprising a CRIRM of the present invention in material form.

By way of yet another nonlimiting example, a personal insect repellent article may comprise a fabric comprising a CRIRM of the present invention and an elastic component and/or a fastener (e.g., Velcro, hook-and-loop, a button, a clip, a hook-and-eye, an adhesive, and the like). Nonlimiting examples of personal insect repellent articles may include armbands, ankle bands, wristbands, and the like.

In some embodiments, products, including any of the aforementioned products, may be configured such that a CRIRM of the present invention may be replaceable, e.g., as a sachet, as a liner, as a reservoir, or the like. By way of nonlimiting example, an outdoor furniture cushion may be capable of receiving a sachet comprising a CRIRM of the present invention. By way of another nonlimiting example, a tent may be configured to have fabrics comprising a CRIRM of the present invention attached thereto. By way of yet another nonlimiting example, a sachet may comprise an air permeable container and a CRIRM of the present invention disposed within an air permeable container.

In some embodiments, products may comprise a CRIRM of the present invention and a reservoir for additional insect repellent and/or insect repellent synergist. By way of nonlimiting example, a personal insect repellent device, e.g., a fan, may comprise a cartridge having liquid insect repellent therein that operably inserts into the device such that the liquid in the cartridge is in fluid communication with the CRIRM of the present invention such that the CRIRM of the present invention controls the release rate of the insect repellent.

In some embodiments, products may comprise a power source. As used herein, the term “power source” refers to a self-contained source of power and/or a component that operably harvests energy from another source (e.g., a plug and a solar cell). In some embodiments, products may comprise a pump to actively transfer insect repellent and/or insect repellent synergist to the CRIRM of the present invention.

In some embodiments, products may comprise an insect repellent reservoir, a power source, and a pump in any combination.

By way of nonlimiting example, a plug-in insect repellent device may comprise a CRIRM of the present invention, a three-pronged plug, a fluid reservoir, and a pump to transfer insect repellent and/or insect repellent synergist from the fluid reservoir to the CRIRM.

By way of another nonlimiting example, a flameless insect repellent candle may comprise a CRIRM of the present invention and a battery source for a faux-flame light. Such application may advantageously allow for the faux-flame light to warm the CRIRM of the present invention by at least a few degrees and increase the rate of insect repellent release, thereby giving the consumer options as to the release rate of the insect repellent.

In some embodiments, consumer options for the release rate of the insect repellent may be more than two levels, e.g., high, medium, and low settings.

IV. Controlled Release from Controlled Release Insect Repellent Materials and Articles or Products Produced Therefrom

Generally, the release rate of an insect repellent or other component (e.g., an insect repellent synergist or an additive) can depend primarily on two factors, (1) the diffusion rate of the insect repellent or other component to the surface (i.e., the diffusion coefficient of the insect repellent or other component through the polymers (e.g., ethylene copolymers, ethyl celluloses, thermoplastic polyurethanes, and an optional additional polymer)) and (2) the evaporation rate of the insect repellent or other component once at the surface. The diffusion rate can be affected by, inter alia, the molecular weight of an insect repellent or other component, the characteristics of a polymer matrix of a CRIRM (e.g., crystallinity of an ethylene copolymer), the temperature, and the like. The evaporation rate can be affected by, inter alia, the volatility of an insect repellent or other component, the temperature, air movement around the surface, and the like.

In some embodiments, a CRIRM of the present invention, or articles or products produced therefrom, may be designed to provide a desired release rate and/or efficacy timeframe of an insect repellent or other component (e.g., an insect repellent synergist or an additive). Suitable design features may include, but are not limited to, the composition and/or concentration of an insect repellent or other component, the relative concentration of two or more components (e.g., an insect repellent, an insect repellent synergist, an additive, or any combination thereof), the characteristics of the polymers (e.g., ethylene copolymers, ethyl celluloses, and/or thermoplastic polyurethanes), the composition and/or concentration of and optional additional polymer, the physical design of a CRIRM of the present invention (e.g., the various forms of CRIRM that result in different surface to volume ratios of the CRIRM), the physical design of an article or product comprising a CRIRM of the present invention (e.g., the inclusion of a controlled release layer in a layered article or the inclusion of an insect repellent in a first layer with the inclusion of an insect repellent synergist in a second layer where the layered article releases the insect repellent and insect repellent synergist at differing rates), or any combination thereof.

In some embodiments, a CRIRM of the present invention, or articles or products produced therefrom, may be designed to provide for an efficacy timeframe in the range of about seconds or minutes to months. That is, while a CRIRM of the present invention, or articles or products produced therefrom, may be advantageously designed to provide for long-term efficacy, a CRIRM of the present invention, or articles or products produced therefrom, may also be designed to provide for in the short-term or medium-term efficacy. Further, a CRIRM of the present invention, or article or products produced therefrom, may be designed to have a dual-efficacy such that two or more components (e.g., an insect repellent, an insect repellent synergist, an additive, or any combination thereof) may independently have different efficacy time frames. By way of nonlimiting example, an outdoor tablecloth comprising a CRIRM of the present invention may be designed to have medium-term efficacy with regards to a first insect repellent (e.g., to repel flies and mosquitoes) and long-term efficacy with regards to a second insect repellent (e.g., to repel ants). By way of another nonlimiting example, a film suitable for diffusion to a wall or window for repelling cockroaches comprising a CRIRM of the present invention may be designed to have short- to medium-term efficacy with regards to an additive like an aroma and long-term efficacy with regards to an insect repellent and an insect repellent synergist, which may advantageously provide for a pleasant smell upon installation of the film and long-term efficacy of the insect repellent/insect repellent synergist combination.

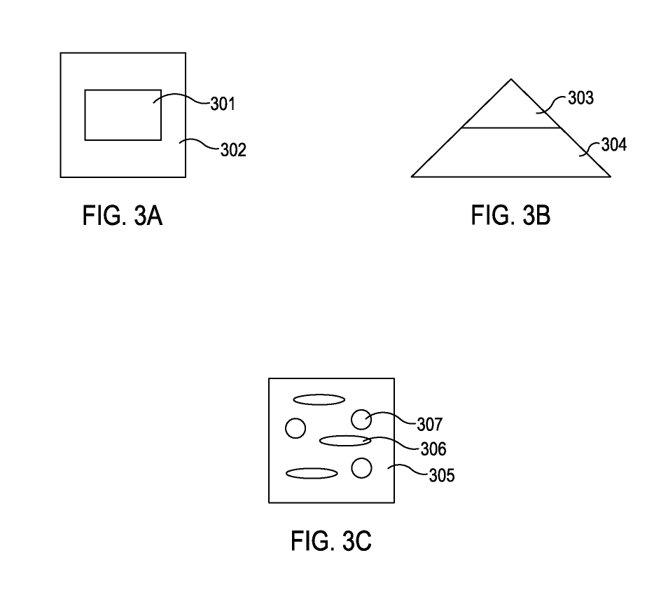

Regarding the physical design of a CRIRM of the present invention, or articles or products produced therefrom, FIGS. 3A-C provide nonlimiting illustrations of possible physical design configurations. FIG. 3A illustrates a rectangular cross-section of a nonlimiting example of a molded article comprising a CRIRM of the present invention, e.g., a decorative outdoor object, with core 301 and sheath 302. Without being bound by theory, core 301 being disposed within sheath 302 may cause a first component disposed in core 301 to diffuse more slowly to a surface of the substrate for release than a second component in sheath 302. The exact choice of dimensions and cross-sectional shape of the molded article and the relative dimensions of core 301 and sheath 302 may be varied in any scale and may depend on, inter alia, the downstream application of the molded article. By way of nonlimiting example, a molded article may be a statue having core 301 comprising a first ethylene copolymer and an insect repellent synergist and sheath 302 comprising a second ethylene copolymer, an insect repellent, and an additive like a colorant and/or fragrance. Further, the first ethylene copolymer may have a higher crystallinity than a second ethylene copolymer, and the insect repellent may be less volatile than the insect repellent synergist. This design incorporating physical structure, relative ethylene copolymer crystallinity, and relative volatility of components to be released, may provide for release over the long-term of the insect repellent synergist at a concentration of about 3 to 5 times the concentration of the insect repellent. In some instances, the ethylene copolymers may be ethylene vinyl acetate.

Similarly, the core/sheath configuration described above translates to layered articles, for example, the nonlimiting example of a layered article shown in FIG. 2F, wherein the inner insect repellent layer 201″ and outer insect repellent layer 201′ provide for similar behavior to core 301 and sheath 302 of FIG. 3A, respectively.

Referring now to a nonlimiting example illustrated in FIG. 3B, an article having triangular cross-section with top portion 303 having a lower surface area than bottom portion 304 may allow for the same or similar release rate of a less volatile component in bottom portion 304 as compared to a more volatile component in top portion 303. Further, the ethylene copolymer crystallinity and an optional additional polymer may be used to engineer a desired diffusion rate of the various components through their respective top portion 303 or bottom portion 304, which may be used to tailor the efficacy timeframe of the article. In some instances, the ethylene copolymers may be ethylene vinyl acetate.

The same principles of surface to volume ratio may be applied to controlled release into the air and diffusion into another polymer. Referring now to a nonlimiting example illustrated in FIG. 3C, an article having polymeric matrix 305 may have first CRIRM 306 and second CRIRM 307 dispersed therein, where first CRIRM has a higher surface area to volume ratio. Accordingly, a first component (e.g., an insect repellent, an insect repellent synergist, an additive, or any combination thereof) dispersed in first CRIRM 306 may be released into polymeric matrix 305 at a higher rate than a second component (e.g., an insect repellent, an insect repellent synergist, an additive, or any combination thereof) dispersed in second CRIRM 307. In such an example, if both the first component and the second component diffuse through polymeric matrix 305 at about the same rate, then generally speaking the release rate of each component will be dependent on the surface area to volume ratio of the CRIRM in which each component is dispersed. By way of nonlimiting example, a first CRIRM in fiber form may be used in conjunction with a second CRIRM in pellet form.

Similarly, where polymeric matrix 305 is replaced with air, the same general principles would apply. By way of nonlimiting example, a fabric formed from a first CRIRM comprising a first ethylene copolymer and a first insect repellent may also include pellets (e.g., with dimensions on the order of millimeters) comprising a second ethylene copolymer and a second insect repellent adhered to the nonwoven fabric (e.g., within the entangled fibers). Such a fabric may be useful as a replaceable insert in a seat cushion (e.g., a portable seat cushion, a patio furniture seat cushion, and the like). In some instances, the ethylene copolymers may be ethylene vinyl acetate.

Another parameter that may be useful in designing articles and products comprising a CRIRM of the present invention is the relative Van Krevelen solubility parameter values between the ethylene copolymers and a component (e.g., an insect repellent, an insect repellent synergist, an additive, or any combination thereof). Referring now to FIG. 3A, an alternate embodiment to that disclosed above, core 301 may comprise an insect repellent and a first ethylene copolymer, while sheath 302 comprises a second ethylene copolymer such that the difference between the Van Krevelen solubility parameter values of the insect repellent and the second ethylene copolymer is greater than the difference between the Van Krevelen solubility parameter values of the insect repellent and the first ethylene copolymer. In some instances, the ethylene copolymers may be ethylene vinyl acetate.

Extending the use of relative Van Krevelen solubility parameter values in the design of articles and products comprising a CRIRM of the present invention, a structure similar to that shown in FIG. 3C may be designed such that first CRIRM 306 and second CRIRM 307 have the same surface area to volume ratio but the relative Van Krevelen solubility parameter values between their respective ethylene copolymer and insect repellent are tailored to provide a desired release rate for each insect repellent. In some instances, the ethylene copolymers may be ethylene vinyl acetate.

### V. Additives

Suitable additives for use in conjunction with the present invention may include, but not be limited to, active particles, active compounds, ion exchange resins, superabsorbent polymers, zeolites, nanoparticles, ceramic particles, abrasive particulates, absorbent particulates, softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof.

Active particles for use in conjunction with the present invention may be useful in actively reducing components from a fluid stream by absorption or reaction. Suitable active particles for use in conjunction with the present invention may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, alumina nanoparticles, magnetic nanoparticles, paramagnetic nanoparticles, superparamagnetic nanoparticles, gadolinium oxide nanoparticles, hematite nanoparticles, magnetite nanoparticles, gado-nanotubes, endofullerenes, Gd@C₆₀, core-shell nanoparticles, onionated nanoparticles, nanoshells, onionated iron oxide nanoparticles, activated carbon, ion exchange resins, desiccants, silicates, molecular sieves, silica gels, activated alumina, zeolites, perlite, sepiolite, Fuller's Earth, magnesium silicate, metal oxides, iron oxides, activated carbon, and any combination thereof.

Suitable active particles for use in conjunction with the present invention may have at least one dimension of about less than one nanometer, such as graphene, to as large as a particle having a diameter of about 5000 nanometers. Active particles for use in conjunction with the present invention may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in conjunction with the present invention, wherein the selected maximum size is greater than the selected minimum size. In some embodiments, the active particles for use in conjunction with the present invention may be a mixture of particle sizes ranging from the above lower and upper limits. In some embodiments of the present invention, the size of the active particles may be polymodal.

Active compounds for use in conjunction with the present invention may be useful in actively reducing components from a fluid stream by absorption or reaction. Suitable active compounds for use in conjunction with the present invention may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, or any combination thereof.

Suitable ion exchange resins for use in conjunction with the present invention may include, but not be limited to, polymers with a backbone, such as styrene-divinyl benezene (DVB) copolymer, acrylates, methacrylates, phenol formaldehyde condensates, and epichlorohydrin amine condensates; a plurality of electrically charged functional groups attached to the polymer backbone; or any combination thereof.

As used herein, the term “superabsorbent materials” refers to materials, e.g., polymers, capable of absorbing at least three times their weight of a fluid. Suitable superabsorbent materials for use in conjunction with the present invention may include, but not be limited to, sodium polyacrylate, starch graved copolymers of polyacrylonitriles, polyvinyl alcohol copolymers, cross-linked poly(ethylene oxides), polyacrylamide copolymers, ethylene maleic anhydride copolymers, cross-linked carboxymethylcelluloses, and the like, or any combination thereof.

Zeolites for use in conjunction with the present invention may include crystalline aluminosilicates having pores, e.g., channels, or cavities of uniform, molecular-sized dimensions. Zeolites may include natural and synthetic materials. Suitable zeolites may include, but not be limited to, zeolite BETA (Na₇(Al₇Si₅₇O₁₂₈) tetragonal), zeolite ZSM-5 (Naₙ(AlₙSi₉₆₋ₙO₁₉₂) 16H₂O, with n<27), zeolite A, zeolite X, zeolite Y, zeolite K-G, zeolite ZK-5, zeolite ZK-4, mesoporous silicates, SBA-15, MCM-41, MCM48 modified by 3-aminopropylsilyl groups, alumino-phosphates, mesoporous aluminosilicates, other related porous materials (e.g., such as mixed oxide gels), or any combination thereof.

Suitable nanoparticles for use in conjunction with the present invention may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagentic nanoparticles like gadolinium oxide, various crystal structures of iron oxide like hematite and magnetite, about 12 nm Fe₃O₄, gado-nanotubes, and endofullerenes like Gd@C₆₀; and core-shell and onionated nanoparticles like gold and silver nanoshells, onionated iron oxide, and other nanoparticles or microparticles with an outer shell of any of said materials; and any combination of the foregoing. It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles for use in conjunction with the present invention may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or 3°), amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetraacetate, diethylenetriaminepentaacetic acid, triglycollamic acid, and a structure comprising a pyrrole ring; and any combination thereof.

Suitable ceramic particles for use in conjunction with the present invention may include, but not be limited to, oxides (e.g., silica, titania, alumina, beryllia, ceria, and zirconia), nonoxides (e.g., carbides, borides, nitrides, and silicides), composites thereof, or any combination thereof. Ceramic particles may be crystalline, non-crystalline, or semi-crystalline.

Suitable softening agents and/or plasticizers for use in conjunction with the present invention may include, but not be limited to, water, glycerol triacetate (triacetin), triethyl citrate, dimethoxy-ethyl phthalate, dimethyl phthalate, diethyl phthalate, methyl phthalyl ethyl glycolate, o-phenyl phenyl-(bis)phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof. One skilled in the art with the benefit of this disclosure should understand the concentration of plasticizers to use as an additive to the filaments.

As used herein, pigments refer to compounds and/or particles that impart color and are incorporated throughout the filaments. Suitable pigments for use in conjunction with the present invention may include, but not be limited to, titanium dioxide, silicon dioxide, carbon black, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, caramel, fruit or vegetable or spice colorants (e.g., beet powder, beta-carotene, turmeric, paprika), or any combination thereof.

As used herein, dyes refer to compounds and/or particles that impart color and are a surface treatment of the filaments. Suitable dyes for use in conjunction with the present invention may include, but not be limited to, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L).

Suitable flavorants for use in conjunction with the present invention may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein. These flavorants may be placed in the tobacco column or in a section of a filter.

Suitable aromas for use in conjunction with the present invention may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders for use in conjunction with the present invention may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers for use in conjunction with the present invention may include, but not be limited to, methylcellulose, ethylcellulose, hydroxyethylcellulose, carboxy methylcellulose, carboxy ethylcellulose, water-soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl(meth)acrylates, acrylamides, N-(dialkyl amino alkyl)acrylamide, methacrylamides, hydroxy alkyl(meth)acrylates, methacrylic acids, acrylic acids, hydroxyethyl acrylates, and the like, any derivative thereof, or any combination thereof.

Suitable lubricating agents for use in conjunction with the present invention may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from nonwater-soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers for use in conjunction with the present invention may include, but not be limited to, sorbitan monolaurate, e.g., SPAN® 20 (available from Uniqema, Wilmington, Del.), or poly(ethylene oxide) sorbitan monolaurate, e.g., TWEEN® 20 (available from Uniqema, Wilmington, Del.).

Suitable vitamins for use in conjunction with the present invention may include, but not be limited to, vitamin B compounds (including B1 compounds, B2 compounds, B3 compounds such as niacinamide, niacinnicotinic acid, tocopheryl nicotinate, C₁-C₁₈ nicotinic acid esters, and nicotinyl alcohol; B5 compounds, such as panthenol or “pro-B5”, pantothenic acid, pantothenyl; B6 compounds, such as pyroxidine, pyridoxal, pyridoxamine; carnitine, thiamine, riboflavin); vitamin A compounds, and all natural and/or synthetic analogs of Vitamin A, including retinoids, retinol, retinyl acetate, retinyl palmitate, retinoic acid, retinaldehyde, retinyl propionate, carotenoids (pro-vitamin A), and other compounds which possess the biological activity of Vitamin A; vitamin D compounds; vitamin K compounds; vitamin E compounds, or tocopherol, including tocopherol sorbate, tocopherol acetate, other esters of tocopherol and tocopheryl compounds; vitamin C compounds, including ascorbate, ascorbyl esters of fatty acids, and ascorbic acid derivatives, for example, ascorbyl phosphates such as magnesium ascorbyl phosphate and sodium ascorbyl phosphate, ascorbyl glucoside, and ascorbyl sorbate; and vitamin F compounds, such as saturated and/or unsaturated fatty acids; or any combination thereof.

Suitable antimicrobials for use in conjunction with the present invention may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexaniethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents (antistats) for use in conjunction with the present invention may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof. Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective antistats.

Embodiments disclosed herein include:

A. a layered article that includes an adhesive layer and an insect repellent layer comprising a controlled release insect repellent material, the controlled release insect repellent material including an insect repellent and at least one polymer selected from the group consisting of an ethylene copolymer, an ethyl cellulose, a thermoplastic polyurethane, and any combination thereof;

B. a molded article that includes a controlled release insect repellent material, the controlled release insect repellent material including an insect repellent and at least one polymer selected from the group consisting of an ethylene copolymer, an ethyl cellulose, a thermoplastic polyurethane, and any combination thereof;

C. a fabric that includes a controlled release insect repellent material in fiber form, the controlled release insect repellent material including an insect repellent and at least one polymer selected from the group consisting of an ethylene copolymer, an ethyl cellulose, a thermoplastic polyurethane, and any combination thereof;

D. a method that includes mixing an insect repellent in a polymer melt comprising at least one polymer selected from the group consisting of an ethylene copolymer, an ethyl cellulose, a thermoplastic polyurethane, and any combination thereof; producing a controlled release insect repellent material from the polymer melt having insect repellent therein; and producing an article comprising the controlled release insect repellent material;

E. a method that includes absorbing an insect repellent into a matrix so as to form a controlled release insect repellent material, the matrix comprising at least one polymer selected from the group consisting of an ethylene copolymer, an ethyl cellulose, a thermoplastic polyurethane, and any combination thereof; and producing an article from the controlled release insect repellent material;

F. a method that includes applying an insect repellent to a surface; and applying a polymer melt to the surface having insect repellent thereon thereby forming a controlled release insect repellent material, the polymer melt comprising at least one polymer selected from the group consisting of an ethylene copolymer, an ethyl cellulose, a thermoplastic polyurethane, and any combination thereof;

G. a method that includes mechanically breaking down a controlled release insect repellent material into particles having at least one dimension ranging from about 10 nm to about 1 mm, the controlled release insect repellent material including an insect repellent and at least one polymer selected from the group consisting of an ethylene copolymer, an ethyl cellulose, a thermoplastic polyurethane, and any combination thereof; and incorporating the particles into a delivery medium or an article;

H. an article that includes a controlled release insect repellent material in fiber form, the controlled release insect repellent material comprising an insect repellent and at least one polymer selected from the group consisting of an ethylene copolymer, an ethyl cellulose, a thermoplastic polyurethane, and any combination thereof;

I. a tablecloth that includes a layer comprising polyvinyl chloride, insect repellent, and at least one polymer selected from the group consisting of an ethylene copolymer, an ethyl cellulose, a thermoplastic polyurethane, and any combination thereof;

J. a window film that includes an adhesive layer; and a controlled release insect repellent material layer comprising insect repellent and at least one polymer selected from the group consisting of an ethylene copolymer, an ethyl cellulose, a thermoplastic polyurethane, and any combination thereof;

K. a carpet that includes a backing that comprises a controlled release insect repellent material in fiber form, the controlled release insect repellent material layer comprising insect repellent and at least one polymer selected from the group consisting of an ethylene copolymer, an ethyl cellulose, a thermoplastic polyurethane, and any combination thereof;

L. a spray that includes a fluid and a controlled release insect repellent material in particle form, the controlled release insect repellent material layer comprising insect repellent and at least one polymer selected from the group consisting of an ethylene copolymer, an ethyl cellulose, a thermoplastic polyurethane, and any combination thereof;

M. a flameless candle that includes a controlled release insect repellent material that comprises insect repellent and at least one polymer selected from the group consisting of an ethylene copolymer, an ethyl cellulose, a thermoplastic polyurethane, and any combination thereof; a faux-flame light that when on is in thermal communication with at least a portion of the controlled release insect repellent material; and a battery source capable of powering the faux-flame light;

N. a poncho that includes a nonwoven fabric comprising a controlled release insect repellent material in fiber form, the controlled release insect repellent material layer comprising insect repellent and at least one polymer selected from the group consisting of an ethylene copolymer, an ethyl cellulose, a thermoplastic polyurethane, and any combination thereof;

O. personal insect repellent article that includes a hook-and-loop fastener and a controlled release insect repellent material comprising insect repellent and at least one polymer selected from the group consisting of an ethylene copolymer, an ethyl cellulose, a thermoplastic polyurethane, and any combination thereof;

P. a sachet that includes an air permeable container; and a controlled release insect repellent material disposed within the air permeable container, the controlled release insect repellent material comprising insect repellent and at least one polymer selected from the group consisting of an ethylene copolymer, an ethyl cellulose, a thermoplastic polyurethane, and any combination thereof;

Q. a netting that includes a controlled release insect repellent material in a form of a fiber, the controlled release insect repellent material comprising insect repellent and at least one polymer selected from the group consisting of an ethylene copolymer, an ethyl cellulose, a thermoplastic polyurethane, and any combination thereof; and

R. a method that includes providing a controlled release insect repellent material in a form of a fiber, the controlled release insect repellent material comprising insect repellent and at least one polymer selected from the group consisting of an ethylene copolymer, an ethyl cellulose, a thermoplastic polyurethane, and any combination thereof; and forming a netting comprising the fiber.

Each of embodiments A through R may independently have one or more of the following additional elements in any combination: Element 1: the controlled release insect repellent material (or corresponding polymer melt) further comprising at least one selected from the group consisting of an additional polymer, an insect repellent synergist, an additive, and any combination thereof; Element 2: the ethylene copolymer having a crystallinity ranging from about 0% to about 60% as determined by differential scanning calorimetry according to ASTM 3418 with scanning rates of 10° C./min, an annealing temperature of 160° C., and an annealing time of 10 minutes; Element 3: the ethylene copolymer having a number of internal segments per chain ranging from about 0.1 to about 50; Element 4: the ethylene copolymer having a Kuhn length ranging from about 5 A to about 30 A; Element 5: the ethylene copolymer having a Van Krevelen solubility parameter value ranging from about 8,380 J/mol to about 31,080 J/mol; Element 6: the ethylene copolymer and the insect repellent having a relative Van Krevelen solubility parameter value of about 5% or less; Element 7: the ethylene copolymer comprising an ethylene monomer and at least one monomer selected from the group consisting of vinyl acetate, a vinyl ester, an acrylate, methyl acrylate, ethyl acrylate, n-butyl acrylate, ethyl methacrylate, acrylic acid, methacrylic acid, neutralized or partially neutralized salts of an acrylic acid, carbon monoxide, propylene, 1-butene, 1-pentene, 1-hexene, 1-heptene, 1-octene, 4-methyl-1-pentene, any derivative thereof, any suitable salt thereof, and any combination thereof; Element 8: the ethylene copolymer comprising ethylene vinyl acetate copolymer; Element 9: the insect repellent being in at least one form selected from the group consisting of a liquid, a solid, dispersed in a solvent, a solid encapsulated by a polymer and/or surfactant, an emulsion, a stabilized emulsion, a microemulsion, and any combination thereof (unless otherwise provided for); Element 10: the controlled release insect repellent material being in at least one form selected from the group consisting of a fiber, a sheet, a pellet, and a particulate (unless otherwise provided for); Element 11: the controlled release insect repellent material being a bicomponent fiber (unless otherwise provided for); Element 12: the insect repellent being present in the controlled release insect repellent material in an amount ranging from about 1% to about 40% by weight of the controlled release insect repellent material; Element 13: the controlled release insect repellent material (or corresponding polymer melt) further comprising an insect repellent synergist in an amount of about 0.1% to about 40% by weight of the controlled release insect repellent material; Element 14: the controlled release insect repellent material (or corresponding polymer melt) further comprising an insect repellent synergist in an amount of about 1 times to about 10 times that of the insect repellent; Element 15: the article comprising at least one selected from the group consisting of a nonwoven article, a woven article, a knit fabric, a molded article, a film, a film with an adhesive backing, a tinted film, a surface covering, and any combination thereof (unless otherwise provided for); Element 15: the article (unless otherwise provided for) being or including at least one of clothing, jewelry, socks, foam sandal, a hat, a handkerchief, a bandanna, a necklace, a rubber bracelet, a poncho, a shoe insert, a shoe liner, a shoe counterliner, a shoe interliner, a shoe reinforcing materials, a sporting fabric, a wristband, a headband, a Velcro-band, a hook-and-loop fastener, a personal care wipe, an antibacterial wipe, a sweat wipe, a baby stroller fabric, an outdoor product, a mosquito net, a planter, patio furniture, an outdoor tableware, an outdoor decoration, a tiki torch, camping equipment, a tent, a folding chair, a seat cushion, a portable seat cushions, a surface covering, wallpaper, a television or computer screen film, a countertop film, a window film, a tinted window film, light fixture finishing films, furniture textile, upholstery, bedware, a quilted product, furniture stuffing, a construction product, a weather strip, insulation, a house wrapping, an insulation product, a home insulation product, a clothing insulation product, a pack insulation product, a vehicle insulation product, a textile insulation product, a noise damping insulation product, a vehicle interior, a headliner, a trunkliner, door trim, a package tray, a sunvisor, a seat, a horticulture product, a plant covering, a flower bed liner, a composite material, a glass-fiber-reinforced plastic, a consumer product, a personal insect repellent patch, a personal insect repellent device, a plug-in insect repellent device, an electronic insect repellent device, an insect repellent candle, a flameless insect repellent candle, a fan, a personal care product, a lotion, a cream, a pet product, a collar, a cage, a pin, a leash, a toy, a urine pad, a window treatment, an inside layer of a tufted carpet or carpet tile, a carpet backing, a container, a bag, a disposable medical product, a bandage, a fluid insect repellent product, a spray, an aerosol, and a paint; and so on.

By way of non-limiting example, exemplary combinations independently applicable to embodiments A through R include: Element 1 in combination with at least one of Elements 2-6; Element 7 in combination with at least one of Elements 2-6; Element 8 in combination with at least one of Elements 2-6; Element 12 in combination with at least one of Elements 2-6; Element 13 in combination with at least one of Elements 2-6; Element 14 in combination with at least one of Elements 2-6; Elements 8, 12, 13, and 14 in combination and optionally in further combination with at least one of Elements 2-6, Element 15 in combination with at least one of Elements 1-14; and so on.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A layered article comprising:
an adhesive layer; and
an insect repellent layer comprising a controlled release insect repellent material that comprises an insect repellent and at least one polymer selected from the group consisting of an ethylene copolymer, an ethyl cellulose, a thermoplastic polyurethane, and any combination thereof.

2. The layered article of claim 1, wherein the controlled release insect repellent material further comprises at least one selected from the group consisting of an additional polymer, an insect repellent synergist, an additive, and any combination thereof.

3. The layered article of claim 1, wherein the ethylene copolymer has a crystallinity ranging from about 0% to about 60% as determined by differential scanning calorimetry according to ASTM 3418 with scanning rates of 10° C./min, an annealing temperature of 160° C., and an annealing time of 10 minutes.

4. The layered article of claim 1, wherein the ethylene copolymer has a number of internal segments per chain ranging from about 0.1 to about 50.

5. The layered article of claim 1, wherein the ethylene copolymer has a Kuhn length ranging from about 5 A to about 30 A.

6. The layered article of claim 1, wherein the ethylene copolymer has a Van Krevelen solubility parameter value ranging from about 8,380 J/mol to about 31,080 J/mol.

7. The layered article of claim 1, wherein the ethylene copolymer and the insect repellent have a relative Van Krevelen solubility parameter value of about 5% or less.

8. The layered article of claim 1, wherein the at least one polymer is an ethylene vinyl acetate copolymer.

9. The layered article of claim 1, wherein the controlled release insect repellent material is a bicomponent fiber.

10. The layered article of claim 1 further comprising:
a backing layer disposed between the adhesive layer and the insect repellent layer.

11. The layered article of claim 1 further comprising:
a release modulation layer such that the insect repellent layer is disposed between the adhesive layer and the release modulation layer.

12. The layered article of claim 1 further comprising:
a peelable layer such that the insect repellent layer is disposed between the adhesive layer and the peelable layer.

13. The layered article of claim 1 further comprising:
a structural layer disposed at least in part between the adhesive layer and the insect repellent layer.

14. A molded article comprising:
a controlled release insect repellent material that comprises an insect repellent and at least one polymer selected from the group consisting of an ethylene copolymer, an ethyl cellulose, a thermoplastic polyurethane, and any combination thereof.

15. The molded article of claim 16, wherein the controlled release insect repellent material further comprises an insect repellent synergist.

16. The molded article of claim 16, wherein the ethylene copolymer has a crystallinity ranging from about 0% to about 60% as determined by differential scanning calorimetry.

17. The molded article of claim 16, wherein the the ethylene copolymer has a number of internal segments per chain ranging from about 0.1 to about 50.

18. The molded article of claim 16, wherein the ethylene copolymer has a Kuhn length ranging from about 5 A to about 30 A.

19. The molded article of claim 16, wherein the at least one polymer is an ethylene vinyl acetate copolymer.

20. A fabric comprising:
a controlled release insect repellent material in fiber form that comprises an insect repellent and at least one polymer selected from the group consisting of an ethylene copolymer, an ethyl cellulose, a thermoplastic polyurethane, and any combination thereof.

21. The fabric of claim 22, wherein the at least one polymer is an ethylene vinyl acetate copolymer.

22. The fabric of claim 22, wherein the fabric is at least a component of a netting.

23. A method comprising:
mixing an insect repellent in a polymer melt comprising at least one polymer selected from the group consisting of an ethylene copolymer, an ethyl cellulose, a thermoplastic polyurethane, and any combination thereof;
producing a controlled release insect repellent material from the polymer melt having insect repellent therein; and
producing an article comprising the controlled release insect repellent material.

24. The method of claim 22, wherein the at least one polymer is an ethylene vinyl acetate copolymer.

25. The method of claim 22, wherein the article is at least a component of at least one selected from the group consisting of clothing, jewelry, a sock, a foam sandal, a hat, a handkerchief, a bandanna, a necklace, a rubber bracelet, a poncho, a shoe insert, a shoe liner, a shoe counterliner, a shoe interliner, a reinforcing material, a sporting fabric, a wristband, a headband, a hook-and-loop fastener, a personal care wipe, an antibacterial wipe, a sweat wipe, a handkerchief, a fabric, a baby stroller fabric, an outdoor product, a mosquito net, a planter, patio furniture, outdoor tableware, an outdoor decoration, a tiki torch, a piece of camping equipment, a tent, a folding chair, a seat cushion, a portable seat cushion, a surface covering, a wallpaper, a television screen film, a computer screen film, a countertop film, a window film, a tinted window film, a light fixture finishing film, a furniture textile, an upholstery, a bedware, a quilted product, a furniture stuffing, a construction product, a weather strip, an insulation, a house wrapping, an insulation product, a home insulation, a clothing insulation, a pack insulation, a vehicle insulation, a textile insulation, a noise damping insulation, a vehicle interior, a headliner, a trunkliner, a door trim, a package tray, a sunvisor, a seat, a horticulture product, a plant covering, a flower bed liner, a composite material, a glass-fiber-reinforced plastic, a consumer product, a personal insect repellent patch, a personal insect repellent device, a plug-in insect repellent device, a electronic insect repellent device, an insect repellent candle, a flameless insect repellent candle, a fan, a personal care product, a lotion, a cream, a pet product, a collar, a cage, a pin, a leash, a toy, a urine pad, a window treatment, an inside layer of tufted carpets and carpet tiles, a carpet backing, a container, a bag, a disposable medical product, a bandage, a band-aid, a fluid insect repellent product, a spray, an aerosol, a paint, and any hybrid thereof.
